(19) United States
(12) Patent Application Publication
(10) Pub. No.: US 2009/0220085 A1
(43) Pub. Date: Sep. 3, 2009

(54) Relay MAC Header for Tunneling in a Wireless Multi-User Multi-Hop Relay Networks

(76) Inventors: Zhifeng Tao, Allston, MA (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/204,093

(22) Filed: Sep. 4, 2008

Related U.S. Application Data
(60) Provisional application No. 60/970,558, filed on Sep. 7, 2007.

(51) Int. Cl. H04L 9/00; H04K 1/00

(52) U.S. Cl. 380/270

(57) ABSTRACT

Provided is a data structure for transmitting a relay media access control (MAC) protocol data unit (PDU) between stations in a multi-hop relay network. The MAC PDU includes an encryption control bit, an allocation subheader bit, a grant management subheader bit, a fragmentation subheader bit, a packing subheader bit, a quality of service subheader bit, and an encryption key sequence. The relay MAC PDU is transmitted in a tunnel established between base station and relay station.

### RELATED APPLICATION

This Application claims priority from U.S. Patent Application Ser. No. 60/970,558, “Encryption and Bandwidth Request and Fragment Sequence Number in Relay MAC Headers” filed by Tao et al. on Sep. 7, 2007, and incorporated herein by reference.

### FIELD OF THE INVENTION

This invention relates generally to wireless multi-user relay networks, and more particularly to a MAC protocol header in wireless multi-user, multi-hop relay (MMR) networks.

### BACKGROUND OF THE INVENTION

Orthogonal frequency-division multiplexing (OFDM) is a modulation technique used at the physical layer (PHY) of a number of wireless networks, e.g., networks designed according to the IEEE 802.11a/g standards, and the IEEE 802.16/16e standards.

OFDMA is a multiple access scheme based on OFDM. In OFDMA, separate sets of orthogonal tones (subchannels) and time slots are allocated to multiple transceivers of mobile stations (MS) or Users so that the transceivers can communicate concurrently. As an example, the IEEE 802.16/16e standard, has adopted OFDMA as the multiple channel access mechanism for non-line-of-sight (NLOS) communications at frequencies below II GHz.

FIG. 1A shows a conventional OFDMA-based cellular network 100, e.g., a wireless network according to the IEEE 802.16/16e standard. The network has a point-to-multipoint topology, wherein only two types of network entity exist, namely base stations (BS), and mobile stations (MS). The BS manages and coordinates all communications with the MS in a particular cell on wireless connections 101-103. Each MS is in direct communication with only one BS, and only the BS communicates with an infrastructure 110 or “backbone” of the network. That is, there is only one hop between the MS and the BS. All communications between the MS must pass through the BS. Furthermore, there is only one connection between the BS and each MS.

Due to significant loss of signal strength along the connection for certain spectrum, the coverage area of the wireless service is often of limited geographical size. In addition, blocking and random fading frequently results in areas of poor reception, or even dead spots in the cell. Conventionally, this problem has been partially addressed by increasing the number of BS. However, the high cost of the BS and potential increase in interference, among others, render this approach less desirable.

As shown in FIG. 1B for an alternative approach, a relay-based network 150 can be used. The network includes multiple mobile stations (MS) and/or subscriber stations (SS). A relatively low-cost relay station (RS) extends the range of the BS. Some of the stations (MS1 and SS1) in close proximity to the BS communicate directly with the BS using connections C1 and C2. Other remote stations (MS2, MS3 and SS2) communicate directly with the RS using connections C3, C4 and C5, and indirectly with the BS via corresponding relay links 151 using two hops. Obviously, communications on the relay links 151 between the RS and BS can become a bottleneck.

As shown in FIG. 2 and in order to effectively address this issue on relay link, the mechanism of aggregation and tunneling is described in United States Patent Application 20080107061, “Communicating packets in a wireless multi-user multi-hop relay networks,” filed by Tao et al. on May 8, 2008. With the introduction of aggregation tunnel 210 in the multi-hop relay network, a wide range of new protocol functions are needed to supported the relay links. The tunnel 210 aggregates the multiple links 151 of FIG. 1B into a single connection and transmits all the traffic between the BS and the RS as a single bit stream. Thus, instead of having to allocate resources to each of the connections 151, a single resource can be allocated to the tunnel 210.

As a result, enhancements to the relay medium access control (MAC) header are described in U.S. patent application Ser. No. 11/770,327, “Protocol Data Units and Header in Multi-hop Relay Network,” file by Tao et al. on Jun. 28, 2007.

### SUMMARY OF THE INVENTION

The embodiments of the invention provide a data structure for a relay medium access control (MAC) header communicated in a mobile multi-hop relay network between stations. The header includes a grant management subheader bit.

### BRIEF DESCRIPTION OF THE DRAWINGS

FIG. 1A is a schematic of a prior art wireless mobile networks;

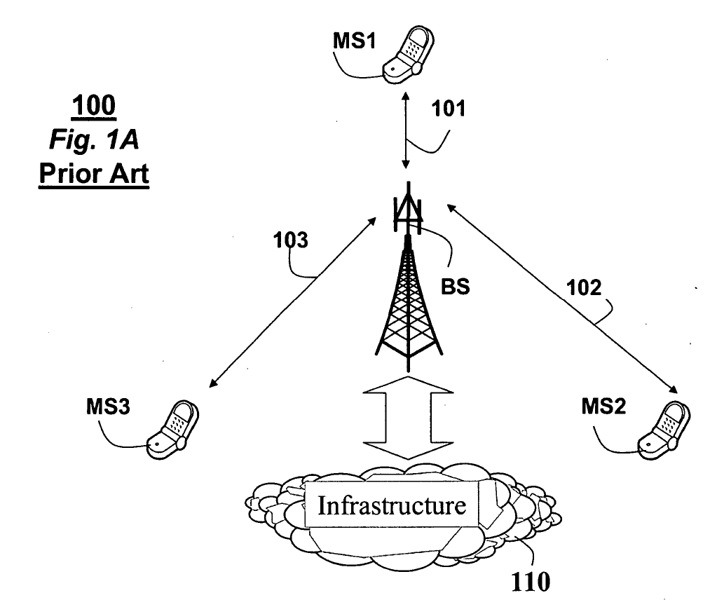

FIG. 1B is a schematic of a prior art wireless mobile relay network;

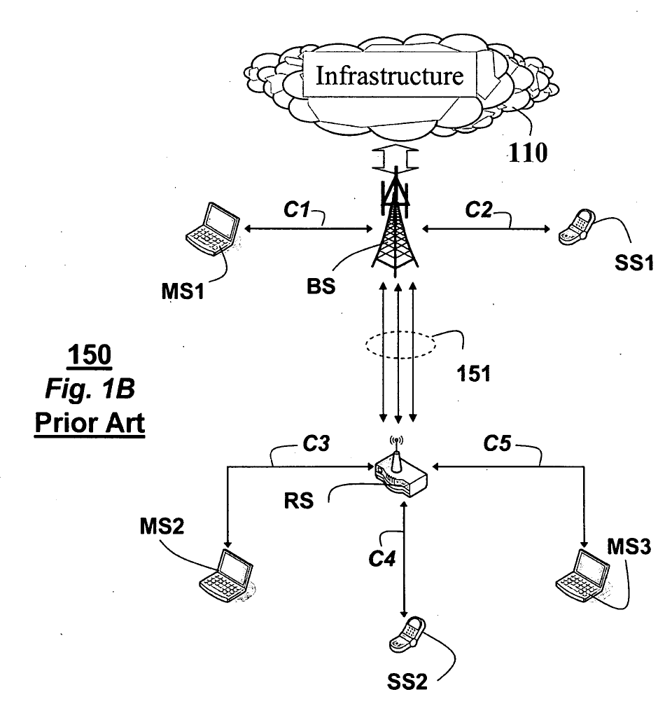

FIG. 2 is a schematic of a wireless mobile relay network according to embodiments of the invention;

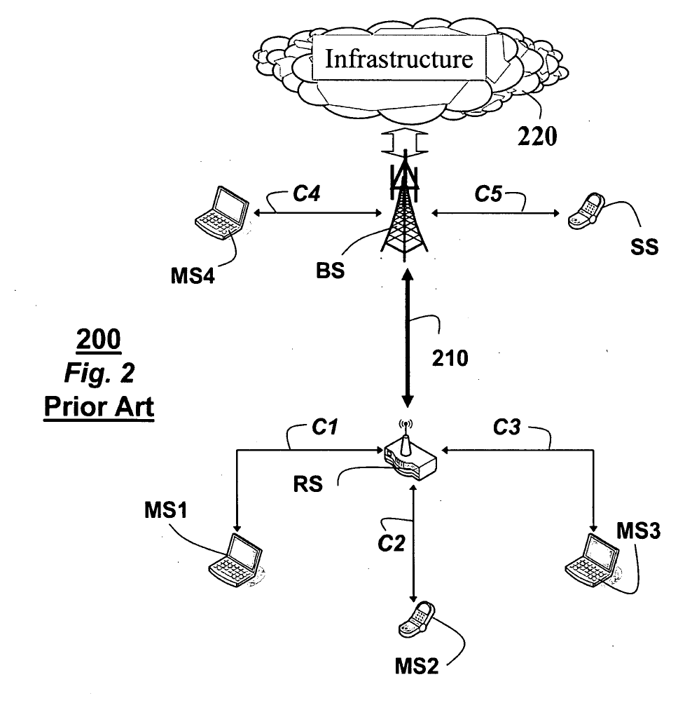

FIG. 3 is block diagram of a format of a prior art relay medium access control (MAC) protocol data unit (PDU);

FIG. 4 is a block diagram of a format of a prior art relay medium access control (MAC) header; and

FIG. 5 is a block diagram of a relay medium access control (MAC) header according to embodiments of the invention.

### DETAILED DESCRIPTION OF THE PREFERRED EMBODIMENTS

### Definitions

For the sake of clarify and the description of the invention the following terms are defined and used accordingly herein.

Base Station (BS)

Equipment to provide wireless communication between subscriber equipment and an infrastructure or network backbone.

Subscriber Station (SS)

A generalized equipment set to provide communication between the subscriber equipment and the base station (BS).

Mobile Station (MS)

A wireless transceiver intended to be used while in motion or at unspecified locations. The MS is always a subscriber station (SS) unless specifically specified otherwise.

Relay Station (RS)

A wireless transceiver whose function is to relay data and control information between other stations, and to execute processes that support multi-hop communications.

Connection

At a physical layer, a wireless connection runs from an RF transmitter of a station via one or more transmit antennas through a wireless channel to an RF receiver of another station via one or more receive antennas. Physically, the connection communicates RF signals using a predetermined set of subchannels and time slots.

At a logical layer, the portion of interest of the connection runs from a media access control (MAC) layer of a protocol stack in the transmitter to the MAC layer in the receiver. Logically, the connection caries data and control information as a single bit stream. For the purpose of this description the connection between the RS and the BS is called a relay link.

MAC Service Data Unit (MSDU)

A set of data specified in a protocol of a given layer and including of protocol control information of that layer, and possibly user data of that layer.

MAC Protocol Data Unit (MPDU)

A protocol data unit of a given layer of a protocol including the service data unit coming from a higher layer and the protocol control information of that layer. A burst is a sequence of contiguous MPDUs that belong to the same connection transmitted as a single, uninterrupted bit stream. The embodiments of the invention use relay MPDUs.

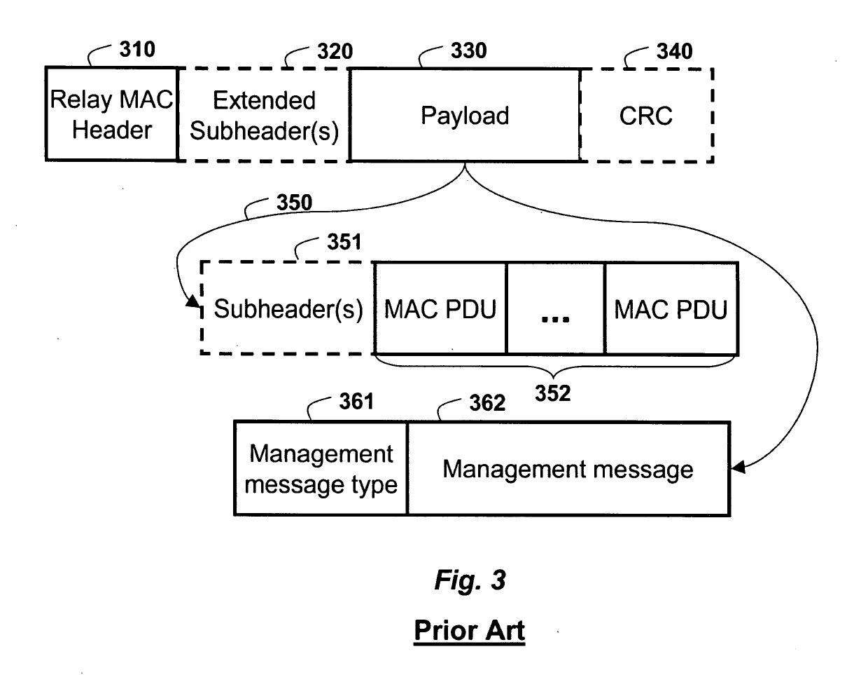

FIG. 3 shows a format for a relay MAC PDU. The relay MAC PDUs transmitted via the tunnel 210 on the relay link is constructed according to this format. Specifically, the relay MAC PDU includes a relay MAC header 310, which is followed by optional extended subheaders 320, a payload 330, and an optional cyclical redundancy check (CRC) 340. The payload can include zero or more subheaders 351 and zero or more MAC PDUs 352. For management purposes, the payload 330 can be a management message type 361 and a management message 362.

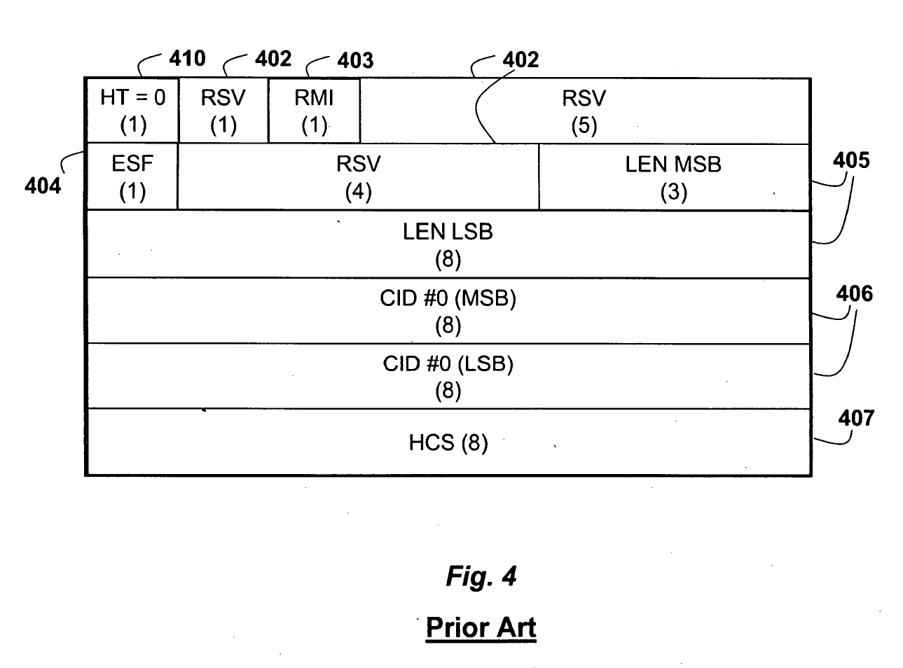

FIG. 4 shows a format for a six byte-long relay MAC header. The number in parenthesis indicates the bit assignment in each byte. Specifically, the header type (HT) bit 401 is set to 0 to indicate that the payload is a MPDU. Six bits are reserved (RSV) 402. The relay mode indication (RMI) bit 403 indicates whether this is a relay MPDU or not.

The extended subheader field (ESF) 404 indicates whether there is any extended subheader included in this relay MAC PDU. The 11-bit length field 405 indicates the length in bytes of the entire relay MAC PDU including the (relay) MAC header, and the CRC (if present). The length field is followed by the 16-bit connection identification (CID) field 406. An 8-bit HCS (header checksum) 407 is appended at the end of the relay MAC header for integrity protection purpose.

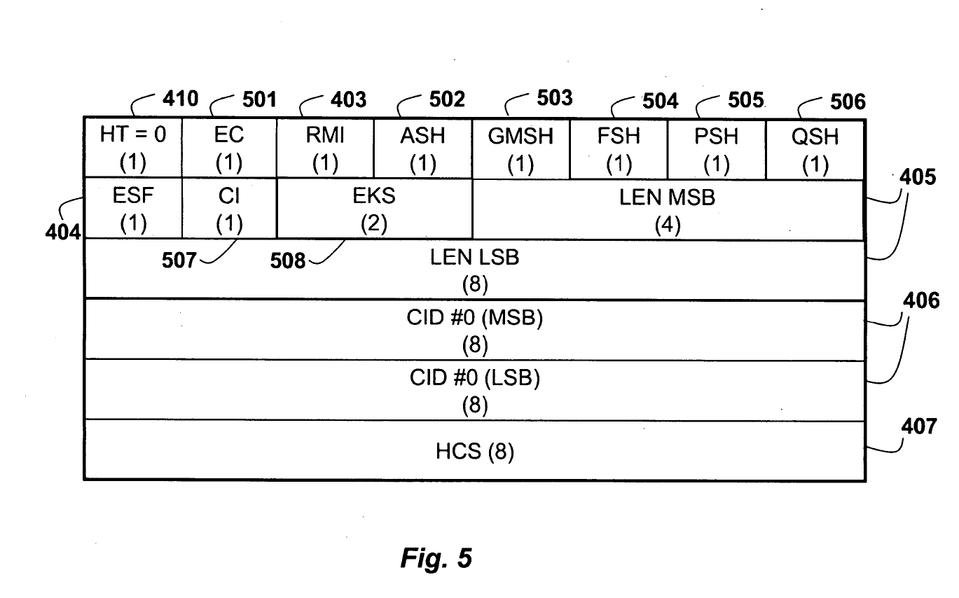

To support a variety of new functions on the relay link 210, the reserved bits 402 are used as shown in FIG. 5. Specifically, the header includes an encryption control (EC) bit 501, an allocation subheader (ASH) bit 502, grant management subheader (GMSH) bit 503, fragmentation subheader (FSH) bit 504, a packing subheader (PSH) bit 505, and a quality of service (QoS) subheader (QSH) bit 506.

There also is a CI bit 507 and an EKS filed 508 described below. Note the length field 405 is now 12 bits to accommodate larger MPDUs for the tunnel.

All the novel bits and fields are described below.

Encryption Control (EC) Bit

If the CID in the relay MAC header indicates that the tunnel 210 is used, then the EC bit 501 indicates whether the payload 330 is encrypted or not.

Allocation Subheader (ASH) Bit

The ASH bit 502 indicates whether an allocation subheader is present or not. The allocation subheader to instruct the RS when to relay the MAC PDU.

Grant Management Subheader (GMSH) Bit

The GMSH bit 503 indicates whether a grant management subheader is present or not in an uplink relay MAC PDU. The grant management subheader is way to attach a request uplink bandwidth without having to create and transmit a complete MPDU with the overhead of MAC headers and CRCs.

Fragmentation Subheader (FSH) Bit

The FSH bit 504 indicates whether a fragmentation subheader is present or not.

Packing Subheader (PSH) Bit

The PSH bit 505 indicates whether a packing subheader is present or not.

Quality of Service (QoS) Subheader (QSH) Bit

The QSH bit indicates whether a QoS subheader is present or not.

CRC Indication (CI) Bit

The CI bit 507 indicates whether the CRC 340 is present or not.

Encryption Key Sequence (EKS) Field

The EKS field 508 indicates the use of an encryption key sequence.

Length Field

This field indicates a total length in bytes of the relay MPDU, including the relay MAC header and the optional CRC field (if present). In order to support a larger payload, the length field in the relay MAC header is 12-bit long. Note that the length field in the conventional IEEE 802.16 generic MAC header (GMH) is 1 I-bit long.

The format for the header of the relay MAC PDU shown in FIG. 5 is further described in Table 1.

| Syntax | | Size | | Notes |
|---|---|---|---|---|
| Relay MAC | | | | |
| Header( ) { | | | | |
| | HT | 1 | bit | 0 |
| | EC | 1 | bit | Encryption control, if CID in the relay MAC |
| | | | | header is a transport tunnel CID |
| | | | | = 0: payload is not encrypted |
| | | | | = 1: payload is encrypted |
| | RMI | 1 | bit | Relay mode indication = 1 |
| | ASH | 1 | bit | Allocation subheader |
| | | | | = 0: allocation subheader is absent |
| | | | | = 1: allocation subheader is present |
| | GMSH | 1 | bit | Grant management subheader (GMSH) in |
| | | | | uplink |
| | | | | = 0: GMSH is absent |
| | | | | = 1 : GMSH is present |
| | FSH | 1 | bit | Fragmentation subheader (FSH) |
| | | | | = 0: FSH is absent |
| | | | | = 1: FSH is present |
| | PSH | 1 | bit | Packing subheader (PSH) |
| | | | | = 0: PSH is absent |
| | | | | = 1: PSH is present |
| | QSH | 1 | bit | QoS subheader (QSH) |
| | | | | = 0: QSH is absent |
| | | | | = 1: QSH is present |
| | ESF | 1 | bit | Extended subheader field. |
| | | | | = 0: the extended subheader is absent. |
| | | | | = 1: the extended subheader is present and |
| | | | | will follow the GMH immediately. |
| | | | | The ESF is applicable both in the DL and in |
| | | | | the UL. |
| | CI | 1 | bit | CRC indicator |
| | | | | = 0: no CRC is included |
| | | | | = 1: CRC is included in the relay MAC PDU |
| | EKS | 2 | bits | Encryption key sequence. |
| | | | | This field contains the index of the traffic |
| | | | | encryption key (TEK) of the access RS |
| | | | | operating in distributed security mode and |
| | | | | initialization vector (IV) used to encrypt the |
| | | | | payload. |
| | LEN | 12 | bits | |
| | CID | 16 | bits | tunnel CID |
| | HCS | 8 | bits | Header check sequence |

}

It is to be understood that various other adaptations and modifications can be made within the spirit and scope of the invention. Therefore, it is the object of the appended claims to cover all such variations and modifications as come within the true spirit and scope of the invention.

We claim:

1. A method for communicating data in a wireless multi-hop relay network, in which the relay network includes a mobile station, a relay station, and a base station, comprising:
establishing a tunnel between the base station and the relay station;
constructing a relay media access control (MAC) protocol data unit (PDU), wherein the relay MAC PDU includes a MAC header and a payload, and wherein the MAC header further comprises:
an encryption control bit to indicate whether the payload is encrypted or not;
an allocation subheader bit to indicate whether an allocation subheader is present or not;
a grant management subheader bit to indicate whether a grant management subheader is present or not in an uplink relay MAC PDU;
a fragmentation subheader bit to indicate whether a fragmentation subheader is present or not;
a packing subheader bit to indicate whether a packing subheader is present or not;
a quality of service subheader bit to indicate whether a QoS subheader is present or not; and
an encryption key sequence to index a traffic encryption key; and
transmitting the relay MAC PDU between the base station and the relay station in the tunnel.

2. The method of claim 1, wherein a length field in the relay MAC PDU header is twelve bits.

3. The method of claim 1, wherein the payload includes one or more medium access control (MAC) protocol data units (PDU).

4. The method of claim 1, wherein the payload is a management message.

5. The method of claim 1, wherein the tunnel aggregates multiple connections between the set of mobile stations and the base station as a single bit stream.

6. The method of claim 1, wherein the relay MAC PDU is constructed by the base station.

7. The method of claim 1, wherein the relay MAC PDU is constructed by the access relay station.
